(19) United States
(12) Patent Application Publication
(10) Pub. No.: US 2008/0278440 A1
(43) Pub. Date: Nov. 13, 2008

(54) Limb image interactive apparatus for information products

(76) Inventor: Hsuan-Yin Chen, Taichung City (TW)

Correspondence Address: Joe McKinney Muncy, PO Box 1364, Fairfax, VA, 22038-1364, US

(21) Appl. No.: 11/798,142

(22) Filed: May 10, 2007

(51) Int. Cl. G09G 5/00

(52) U.S. Cl. 345/156

(57) ABSTRACT

A limb image interactive apparatus for information products aims to directly maneuver varying image interfaces on a display interface of the information products through movements of user's hands and feet such as dancing, exercises or data entry without relying on conventional input interfaces such as joysticks, stepping pads and screen keyboards. Image interactions on the screen can be directly and interactively maneuvered easily through the movements of user's limbs such as hands and feet to provide a more humanized operation and control interface.

### FIELD OF THE INVENTION

The present invention relates to an image interactive apparatus for information products and particularly to an apparatus that directly controls varying image interfaces on a displayed picture through user's limbs to facilitate operation and provide more delicate and humanized maneuvering.

### BACKGROUND OF THE INVENTION

These days people have a higher demand for living quality. One of the important factors that determines the living quality is the availability and enjoyment of more diversified entertainment activities. Meanwhile, advance of electronic and information technologies have made various electronic products important tools to provide entertainment activities. For instance, CD players, VCD or DVD movies, electronic exercise and fitting equipments, computer game devices and the like are very popular at present.

Computer game devices can provide interactive function, thus have a great appeal to people living in the modern society. They also enable users to get a sense of accomplishment and enhance brain power and coordination ability during the game process.

At present all computer game device companies have constantly invested a great amount of capitals to develop novel interactive software and hardware of computer games. As the interactive computer game business is pollution free and has high added value, it is highly encouraged by governments worldwide. Research and development and innovation are thriving.

Among the interactive games the music interactive game is one that attracts a lot of attention. The music interactive game generally provides a feature that includes animation and music rhythm. It requires players to perform selected interactions according to the animation and music rhythm. Based on the coordination of the players the result of the game is obtained. During the interactive game the players not only can enjoy music and amusing animation, also can develop coordination ability and get a sense of accomplishment.

To make the interactive game novel and attractive the interactive picture and interactive device have to be diversified. For instance, a dancing machine based on a sensing board is an optical sensitive game which includes a stepping pad, a host and a screen and can provide many different pleasures for players. Some other games allow users to control and maneuver interactions with varying images on a computer screen through a screen keyboard, such as typing, game playing and the like. They also have appeal to many people.

As the players become more demanding and more diversified, how to develop a novel mechanism to give the players more satisfaction and enhance the value of the interactive game becomes a very challenging task.

### SUMMARY OF THE INVENTION

The primary object of the present invention is to provide a limb image interactive apparatus for information products that directly controls varying image interfaces of a display interface of various information products through user's hands and feet, such as dancing, exercises or data entry without relying on the conventional methods of joysticks or stepping pads and a screen keyboard to perform various image interactions on the screen and computer screen, such as typing, game playing, software operation and the like.

The invention includes a limb operation controller installed on user's limbs. The limb operation controller has a plurality of sensors to transmit maneuvering signals of user's limb movements through a transmission device to a display unit. The display unit aims to display varying image interactive games and a keyboard control interface.

By means of the invention the sensors of the limb operation controller can send the movement signals of user's limbs, such as the signals generated by the movements of user's hands or feet to the display unit to create image interactions with the game on the display unit, and the keyboard control interface can be maneuvered to enter text and numerals and execute software.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an embodiment of the invention.

FIG. 2 is a schematic view of another embodiment of the invention.

### DETAILED DESCRIPTION OF THE PREFERRED EMBODIMENTS

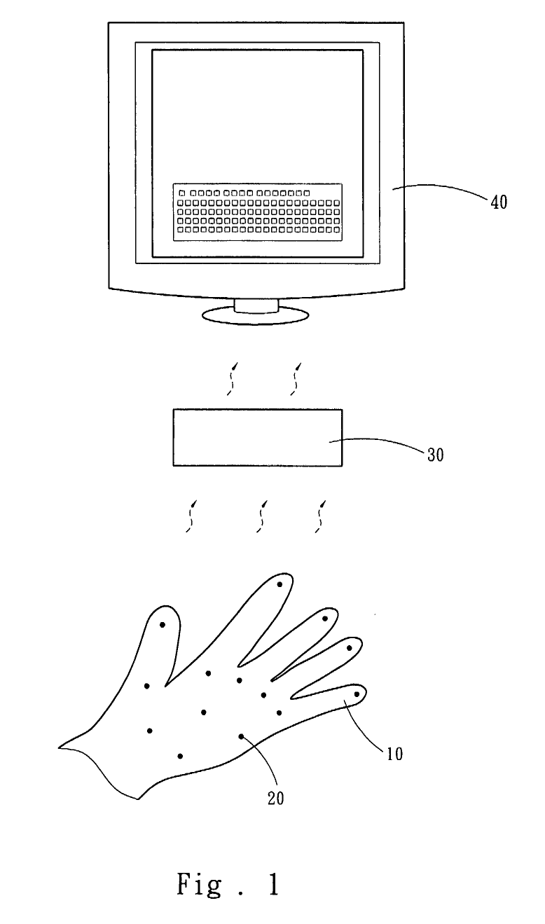

Please refer to FIG. 1 for an embodiment of a hand-controlled type limb operation controller of the invention. It includes:

a limb operation controller 10 operable by a user's hand that is installed on the user's hand. The limb operation controller 10 has a plurality of sensors 20 which transmit maneuvering signals of user's hand movements through a transmission device 30 in a wired or wireless approach to a display unit 40.

The display unit 40 aims to display various image interactive games and a keyboard control interface. When in use user's hand is disposed in the limb operation controller 10, through the sensors 20 signals of the movement of every joint of the user's hand (such as longitudinal and transverse bending of fingers, longitudinal and transverse movements of the palm) are transmitted through the transmission device 30 to the display unit 40.

Thus the user can treat the limb operation controller 10 as one hand and maneuver the game on the display unit 40 through the sensors 20 to generate image interaction effect. The keyboard control interface on the display unit 40 may also be maneuvered to perform typing operation such as text and numerals entry and execution of selected software.

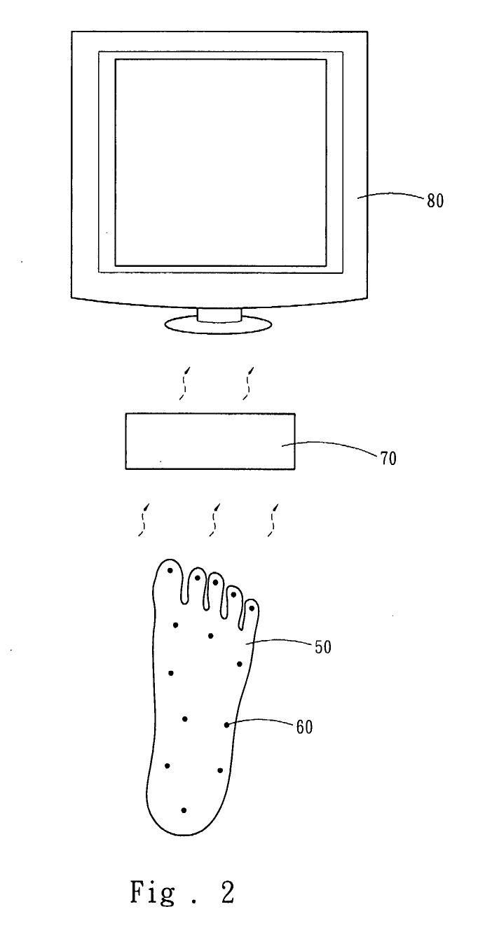

Refer to FIG. 2 for another embodiment of a foot-controlled type limb operation controller of the invention. It includes a limb operation controller 50 operable by a user's foot that is installed on the user's foot. The limb operation controller 50 has a plurality of sensors 60 that transmit maneuvering signals of user's foot movements through a transmission device 70 to a display unit 80.

The display unit 80 aims to display various image interactive games. When in use user's foot is disposed in the limb operation controller 50, through the sensors 60 signals of the movement of every joint of the user's foot (such as longitudinal and transverse bending of toes, longitudinal and transverse movements of the sole) are transmitted through the transmission device 70 to the display unit 80. Thus the user can treat the limb operation controller 50 as one foot and maneuver the game on the display unit 80 through the sensors 60 to generate image interaction effect. Thereby the user can do exercise and also play games at the same time.

In short, by means of the limb operation controller 10 (hand-controlled type) or 50 (foot-controlled type) varying images or operation interfaces displayed on the display unit 40 or 80 can be directly controlled as if it is user's hand or foot. It offers a great improvement over the conventional techniques which rely on an operation interface (such as the stepping pad of a game player or a computer screen keyboard). Operation also is more humanized.

It is to be noted that the invention mainly aims to directly maneuver various images or operation interfaces displayed on the display unit 40 or 80 through user's hand or foot. The limb operation controller 10 or 50 may be designed for single hand or foot, or two hands or feet. There is no limitation on the profile of the limb operation controller 10 or 50. It can be designed for only finger tips or toe tips without including the palm or sole. Selection of such a design depends on user's requirements.

What is claimed is:

1. A limb image interactive apparatus for information products, comprising:
a limb operation controller installed on a user's limb that has a plurality of sensors to transmit signals of limb movement through a transmission device to a display unit which displays varying images of interactive games and a keyboard control interface such that an image interaction is generated with an image interactive game shown on the display unit and text and numeral entry is accomplished through the keyboard control interface and selected software are executed.

2. The limb image interactive apparatus of claim 1, wherein the limb operation controller is a hand operation controller installed on a user's hand.

3. The limb image interactive apparatus of claim 1, wherein the limb operation controller is a foot operation controller installed on a user's foot.

4. The limb image interactive apparatus of claim 1, wherein the transmission device is a wireless transmission means.

5. The limb image interactive apparatus of claim 1, wherein the transmission device is a wired transmission means.
